(19) United States
(12) Patent Application Publication
(10) Pub. No.: US 2025/0210832 A1
(43) Pub. Date: Jun. 26, 2025

(54) METHOD OF MANUFACTURING A POWER STORAGE DEVICE, AND POWER STORAGE DEVICE

(71) Applicant: TOYOTA JIDOSHA KABUSHIKI KAISHA, Aichi-ken (JP)

(72) Inventors: Takeru HARA, Toyota-shi (JP); Shinji SUZUKI, Kariya-shi (JP)

(21) Appl. No.: 18/985,027

(22) Filed: Dec. 18, 2024

(30) Foreign Application Priority Data
Dec. 21, 2023 (JP) 2023-216076

(51) Int. Cl. H01M 50/627

(52) U.S. Cl. CPC H01M 50/627

(57) ABSTRACT

A method of manufacturing a power storage device, which has a battery, injection ports, a tubular member surrounding the injection ports, and a laminate film, includes a step of causing the laminate film to contact the tubular member and welding by heat pressing. At the tubular member, a first region including a surface that contacts the laminate film is structured by resin L, and a second region that is disposed further toward the injection ports side than the first region and that contacts the first region is structured by resin H. At the laminate film, a third region including a surface that contacts the tubular member is structured by resin lam. Melting points Tm or glass transition temperatures Tg of the resin L and the resin lam are lower than that of the resin H. A temperature of the heat pressing is greater than or equal to the melting point Tm or the glass transition temperature Tg of the resin L and the resin lam, and is less than the melting point Tm or the glass transition temperature Tg of the resin H.

### CROSS-REFERENCE TO RELATED APPLICATION

This application is based on and claims priority under 35 USC 119 from Japanese Patent Application No. 2023-216076 filed on Dec. 21, 2023, the disclosure of which is incorporated by reference herein.

### BACKGROUND

### Technical Field

The present disclosure relates a power storage device manufacturing method and a power storage device.

### Related Art

Power storage devices having a battery, injection ports for injecting an electrolyte liquid into the battery, and a tubular member surrounding the injection ports, have been used conventionally.

For example, Japanese Patent Application Laid-Open (JP-A) No. 2020-173921 discloses a power storage module manufacturing method that includes a welding step of joining and integrating, by hot plate welding, a module main body having a sealing member, and a pressure adjusting valve having a case. In the welding step, by using a hot plate welding device having a hot plate main body and a thin-plate-shaped cover plate formed from a rigid body that has high thermal conductivity and is detachably mounted to the hot plate main body, joining projections of the sealing member and joining projections of the case are respectively made to abut the outer surface of the cover plate. At the time when the joining projections are heated and melted such that the melted amounts thereof become amounts that are respectively set in advance, the joining projections are moved away from the outer surface of the cover plate, and then the joining projections and the joining projections are made to contact one another under pressure.

### SUMMARY

In conventional power storage device manufacturing methods, and specifically, in methods of manufacturing a power storage device in which the entire tubular member that surrounds the injection ports is formed of one type of resin, at the time of welding a laminate film and the tubular member by heat pressing, voids may form in the tubular member. The reason why voids form is thought to be as follows. At the tubular member, the resin that is in the vicinity of the surface thereof that contacts the laminate film is melted by the heat pressing, and the fluidity thereof increases. If, in this state, the tubular member is pushed-in the direction in which pressure is applied in the heat pressing, the internal pressure of the spaces within the tubular member rises. Due to the internal pressure becoming too high, the air within the spaces breaks-through and bulges-out molten portions of the resin that structures the tubular member. Due thereto, voids may form in the places of the tubular member that are broken-through by the air within the spaces.

The present disclosure was made in view of the above-described circumstances, and an object thereof is to provide a power storage device manufacturing method that can obtain good sealability of the spaces within a tubular member that communicate with injection ports, and a power storage device that can obtain good sealability of the spaces within a tubular member that communicate with holes communicating with the interior of a battery.

Means for achieving the above-described object include the following aspects.

A method of manufacturing a power storage device of a first aspect of the present disclosure having a battery, injection ports for injecting an electrolyte liquid into the battery, a tubular member surrounding the injection ports, and a laminate film welded to the tubular member and sealing spaces within the tubular member that communicate with the injection ports, the method including:
a step of welding the tubular member and the laminate film by causing the laminate film to contact the tubular member and carrying out heat pressing from the laminate film side,
wherein
at the tubular member, a first region including a surface that contacts the laminate film is structured by resin L, and a second region that is disposed further toward the injection ports side than the first region and that contacts the first region is structured by resin H, and, at the laminate film, a third region including a surface that contacts the tubular member is structured by resin lam, and
melting points Tm or glass transition temperatures Tg of the resin L, the resin H and the resin lam satisfy following conditions a, b and c.
   a: Melting point Tm or glass transition temperature Tg of the resin L is less than melting point Tm or glass transition temperature Tg of the resin H.
   b: Melting point Tm or glass transition temperature Tg of the resin lam is less than the melting point Tm or the glass transition temperature Tg of the resin H.
   c: A temperature of the heat pressing is greater than or equal to the melting point Tm or the glass transition temperature Tg of the resin L, is greater than or equal to the melting point Tm or the glass transition temperature Tg of the resin lam, and is less than the melting point Tm or the glass transition temperature Tg of the resin H.

The method of manufacturing a power storage device of a second aspect according to the present disclosure is the method of manufacturing a power storage device of the first aspect, wherein the resin H is polypropylene, and the resin L and the resin lam are polyethylene.

The method of manufacturing a power storage device of a third aspect according to the present disclosure is the method of manufacturing a power storage device of the first aspect or the second aspect, wherein a shape of the battery as seen in a thickness direction of the battery is rectangular, and lengths of sides of the rectangle are a height of greater than or equal to 1000 mm and a width of greater than or equal to 10,000 mm.

The method of manufacturing a power storage device of a fourth aspect according to the present disclosure is the method of manufacturing a power storage device of any one of the first aspect to the third aspect, wherein the tubular member has convex/concave shapes at surfaces where the second region and the first region contact one another.

The method of manufacturing a power storage device of a fifth aspect according to the present disclosure is the method of manufacturing a power storage device of any one of the first aspect to the third aspect, wherein, at the tubular member, surfaces where the second region and the first region contact one another are shapes that latch at a time when the first region is tensed in a direction toward a side opposite the injection ports.

A power storage device of a sixth aspect of the present disclosure including:
a battery;
holes communicating with an interior of the battery;
a tubular member surrounding the holes; and
a laminate film welded to the tubular member and sealing spaces within the tubular member that communicate with the holes,
wherein
at the tubular member, a first region including a surface that contacts the laminate film is structured by resin L, and a second region that is disposed further toward the holes side than the first region and that contacts the first region is structured by resin H, and, at the laminate film, a third region including a surface that contacts the tubular member is structured by resin lam, and
melting points Tm or glass transition temperatures Tg of the resin L, the resin H and the resin lam satisfy following conditions a and b.
   a: Melting point Tm or glass transition temperature Tg of the resin L is less than melting point Tm or glass transition temperature Tg of the resin H.
   b: Melting point Tm or glass transition temperature Tg of the resin lam is less than the melting point Tm or the glass transition temperature Tg of the resin H.

The power storage device of a seventh aspect according to the present disclosure is the power storage device of the sixth aspect, wherein the resin H is polypropylene, and the resin L and the resin lam are polyethylene.

The power storage device of an eighth aspect according to the present disclosure is the power storage device of the sixth aspect or the seventh aspect, wherein a shape of the power storage device as seen in a thickness direction of the power storage device is rectangular, and lengths of sides of the rectangle are a height of greater than or equal to 1000 mm and a width of greater than or equal to 10,000 mm.

The power storage device of a ninth aspect according to the present disclosure is the power storage device of any one of the sixth aspect to the eighth aspect, wherein the tubular member has convex/concave shapes at surfaces where the second region and the first region contact one another.

The power storage device of a tenth aspect according to the present disclosure is the power storage device of any one of the sixth aspect to the eighth aspect, wherein, at the tubular member, surfaces where the second region and the first region contact one another are shapes that latch at a time when the first region is tensed in a direction toward a side opposite the holes.

In accordance with the present disclosure, there are provided a power storage device manufacturing method that can obtain good sealability of the spaces within a tubular member that communicate with injection ports, and a power storage device that can obtain good sealability of the spaces within a tubular member that communicate with holes communicating with the interior of a battery.

### BRIEF DESCRIPTION OF THE DRAWINGS

FIG. 1 is a schematic perspective view illustrating an example of a power storage device relating to an embodiment of the present disclosure;

FIG. 2 is an exploded perspective view illustrating a portion of the power storage device relating to the embodiment of the present disclosure illustrated in FIG. 1;

FIG. 3 is a schematic sectional view illustrating a portion of the power storage device relating to the embodiment of the present disclosure illustrated in FIG. 1;

FIG. 4 is a schematic sectional view illustrating an example of one step of a power storage device manufacturing method relating to an embodiment of the present disclosure.

FIG. 5 is a schematic sectional view illustrating another example of the power storage device relating to the embodiment of the present disclosure.

FIG. 6 is a schematic sectional view illustrating another example of the power storage device relating to the embodiment of the present disclosure.

FIG. 7 is a schematic sectional view illustrating another example of the power storage device relating to the embodiment of the present disclosure.

FIG. 8 is a schematic sectional view illustrating another example of the power storage device relating to the embodiment of the present disclosure.

FIG. 9 is a schematic sectional view illustrating another example of the power storage device relating to the embodiment of the present disclosure.

### DETAILED DESCRIPTION

Embodiments that are examples of the present disclosure are described hereinafter. The explanation thereof and the Examples exemplify embodiments, and do not limit the scope of the invention.

In numerical value ranges that are expressed in a stepwise manner in the present specification, the maximum value or the minimum value listed in a given numerical value range may be substituted by the maximum value or the minimum value of another numerical value range that is expressed in a stepwise manner. Further, the maximum values or minimum values of the numerical value ranges mentioned in the present specification may be replaced by values shown in the Examples.

Each component may include a plurality of corresponding substances.

In a case in which there are plural types of substances that correspond to a component within a composition, the amount of that component in the composition means the total amount of the plural types of substances existing in the composition, unless otherwise indicated. “Step” is not only an independent step and includes steps that, even in a case in which that step cannot be clearly distinguished from another step, achieve the intended object of that step.

### Power Storage Device and Manufacturing Method Thereof

A power storage device manufacturing method relating to an embodiment of the present disclosure is a method of manufacturing a power storage device having a battery, injection ports for injecting an electrolyte liquid into the battery, a tubular member surrounding the injection ports, and a laminate film welded to the tubular member and sealing spaces within the tubular member that communicate with the injection ports.

This power storage device manufacturing method has a step of welding the tubular member and the laminate film by causing the laminate film to contact the tubular member and carrying out heat pressing from the laminate film side.

At the tubular member, a first region including the surface that contacts the laminate film is structured by resin L, and a second region that is disposed further toward the injection ports side than the first region and that contacts the first region is structured by resin H. At the laminate film, a third region including the surface that contacts the tubular member is structured by resin lam.

Melting points Tm or glass transition temperatures Tg of resin L, resin H and resin lam satisfy following conditions a, b and c.
a: The melting point Tm or glass transition temperature Tg of resin L is less than the melting point Tm or the glass transition temperature Tg of resin H.
b: The melting point Tm or glass transition temperature Tg of resin lam is less than the melting point Tm or the glass transition temperature Tg of resin H.
c: The temperature of the heat pressing is greater than or equal to the melting point Tm or the glass transition temperature Tg of resin L, is greater than or equal to the melting point Tm or the glass transition temperature Tg of resin lam, and is less than the melting point Tm or the glass transition temperature Tg of resin H.

A power storage device relating to an embodiment of the present disclosure has a battery, holes communicating with an interior of the battery, a tubular member surrounding the holes, and a laminate film welded to the tubular member and sealing spaces at the interior of the tubular member that communicate with the holes.

At the tubular member, a first region including the surface that contacts the laminate film is structured by resin L, and a second region that is disposed further toward the holes side than the first region and that contacts the first region is structured by resin H. At the laminate film, a third region including the surface that contacts the tubular member is structured by resin lam.

Melting points Tm or glass transition temperatures Tg of resin L, resin H and resin lam satisfy the above-described conditions a and b.

The holes are not particularly limited provided that they communicate with the interior of the battery, and injection ports are an example thereof.

Hereinafter, there are cases in which the “holes” are simply called the “injection ports”. Further, there are cases in which the “tubular member” is simply called the “injection port frame”.

Here, the structure of the power storage device relating to the embodiment of the present disclosure, and the power storage device manufactured by the power storage device manufacturing method relating to the embodiment of the present disclosure, will be described by way of examples. In the explanation of the drawings, elements that are the same or similar are denoted by the same reference numerals, and repeat description is omitted.

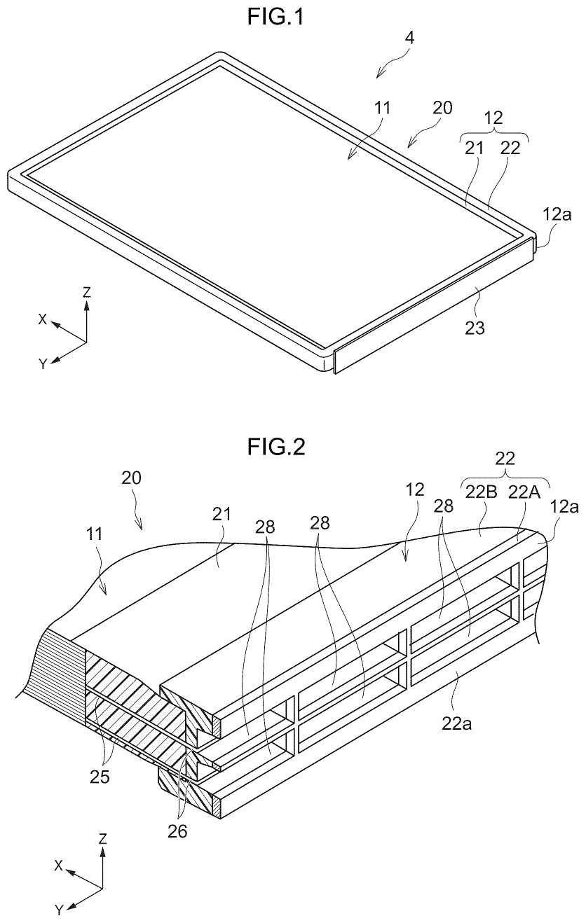

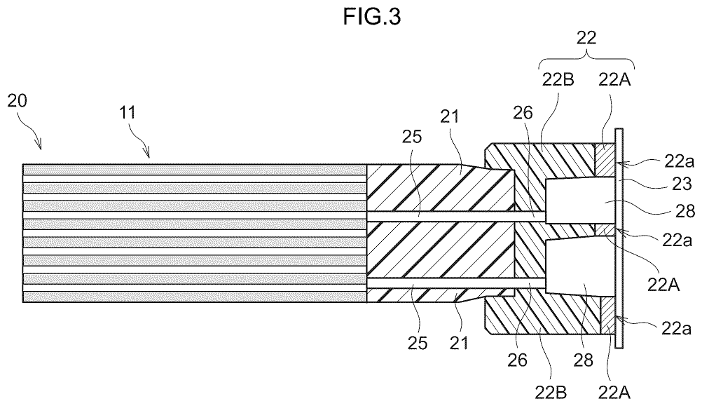

FIG. 1 is a schematic perspective view of the power storage device. FIG. 2 is an exploded perspective view illustrating a portion of the power storage device (and includes a partial sectional view). FIG. 3 is a cross-sectional view illustrating a portion of the power storage device. As illustrated in FIG. 1 and FIG. 3, power storage device 4 has a device main body 20, and a laminate film 23 welded to the device main body 20. Note that FIG. 1 and FIG. 3 illustrate a state in which the laminate film 23 is welded to a wall portion 12a of a sealing member 12, and the laminate film 23 is omitted in FIG. 2.

The device main body 20 has an electrode stack 11 serving as an example of the battery, and the sealing member 12 made of resin and sealing the electrode stack 11. The electrode stack 11 is structured by plural electrodes that are layered via separators. These electrodes may be structured to include, for example, a stack of plural bipolar electrodes, a negative final end electrode, and a positive final end electrode.

The shape of a battery such as the electrode stack 11, as seen from the thickness direction of the battery (i.e., as seen from the layering direction of the electrode stack 11), is rectangular. Note that, here, “rectangular” includes not only a case of an exact rectangle (e.g., an oblong, a square), and also includes cases in which the battery on the whole is a shape that resembles rectangular. Accordingly, this “rectangular” also includes, for example, shapes that resemble rectangles whose corners are slightly rounded.

Further, the rectangular battery can be made to be a size such that the lengths of the sides of the rectangle are a height of greater than or equal to 1000 mm and a width of greater than or equal to 10,000 mm.

The sealing member 12 is formed in the shape of a rectangular tube on the whole. The sealing member 12 is disposed at the side surfaces of the electrode stack 11. The sealing member 12 has plural primary seals 21, and a secondary seal 22 that surrounds the primary seals 21 from the outer sides along the side surfaces of the electrode stack 11 and is joined to the respective primary seals 21. The primary seals 21 are, for example, films having a predetermined thickness in the layering direction.

The secondary seal 22 is provided at the outer sides of the electrode stack 11 and the primary seals 21, and structures the outer wall (the housing) of the power storage device 4. The secondary seal 22 extends over the entire length of the electrode stack 11 along the layering direction. The secondary seal 22 is formed in the shape of a rectangular frame that extends with the axial direction thereof being the layering direction. The secondary seal 22 is welded to the outer surfaces of the primary seals 21 for example. From the standpoint of reducing the manufacturing cost, the secondary seal 22 may be formed at a portion of the outer surfaces of the primary seals 21, e.g., may be formed at the portion that has injection ports 25.

The primary seals 21 and the secondary seal 22 form internal spaces between adjacent electrodes of the electrode stack 11, and seal the internal spaces. An electrolyte liquid (not illustrated), which contains a non-aqueous solvent and an electrolyte salt dissolved in the non-aqueous solvent for example, is accommodated in the internal spaces. The electrolyte liquid is impregnated into, for example, the separators, positive electrodes and negative electrodes that structure the electrode stack 11.

The plural injection ports 25 are respectively provided in the one wall portion 12a that structures the sealing member 12. The injection ports 25 communicate respectively with the internal spaces of the different cells.

The secondary seal 22 structures the injection port frame that surrounds the injection ports 25 at the wall portion 12a. Plural injection ports 26 that communicate with the respective injection ports 25 are respectively provided in the secondary seal 22. The electrolyte liquid is injected into the internal spaces through the injection ports 25, 26.

At the secondary seal 22, at the regions of the wall portion 12a that structure the injection port frame, an outer side region 22A corresponding to a first region that includes the surface contacting the laminate film 23, i.e., a wall surface 22a at the secondary seal 22, is structured by the resin L. Further, at the secondary seal 22, an inner side region 22B corresponding to a second region, which contacts the outer side region 22A and is disposed further toward the injection ports 26 side than the outer side region 22A that includes the surface that contacts the laminate film 23, is structured by the resin H.

The laminate film 23 is welded to the wall surface 22a of the outer side region 22A at the secondary seal 22 that structures the injection port frame. Due to the laminate film 23 being welded to the wall surface 22a, spaces 28 within the secondary seal 22 that communicate with the injection ports 25, 26 are sealed by the laminate film 23. At the laminate film 23, the region corresponding to a third region that includes the surface contacting the wall portion 12a of the secondary seal 22 is structured by the resin lam. Note that the secondary seal 22 is structured by, for example, a metal layer, the resin lam layer that structures the surface that is one surface of the metal layer and contacts the wall portion 12a, and a protective resin layer that structures the other surface of the metal layer, i.e., the surface at the side that does not contact the wall portion 12a.

Further, the respective melting points Tm or glass transition temperatures Tg of the resin L that structures the outer side region 22A including the wall surface 22a of the secondary seal 22, the resin H that structures the inner side region 22B of the secondary seal 22, and the resin lam that structure the surface of the laminate film 23 that contacts the wall portion 12a of the secondary seal 22, satisfy following conditions a, b, and c.
a: The melting point Tm or glass transition temperature Tg of resin L is less than the melting point Tm or the glass transition temperature Tg of resin H.
b: The melting point Tm or glass transition temperature Tg of resin lam is less than the melting point Tm or the glass transition temperature Tg of resin H.
c: The temperature of the heat pressing is greater than or equal to the melting point Tm or the glass transition temperature Tg of resin L, is greater than or equal to the melting point Tm or the glass transition temperature Tg of resin lam, and is less than the melting point Tm or the glass transition temperature Tg of resin H.

### Power Storage Device Manufacturing Method

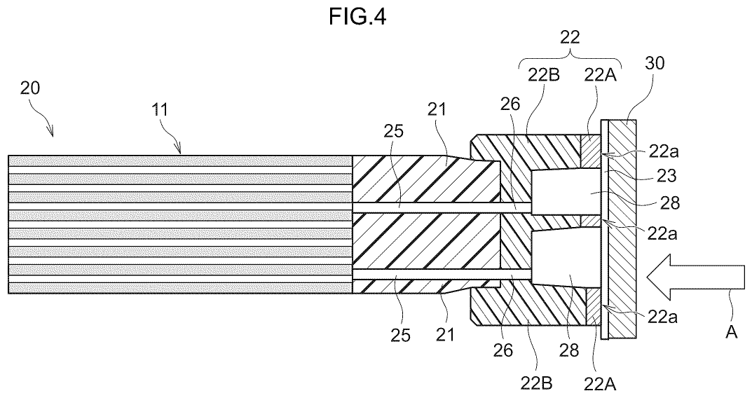

As illustrated in FIG. 4, the power storage device manufacturing method relating to the embodiment of the present disclosure has a step of joining the wall surface 22a and the laminate film 23 by carrying out heat pressing from the laminate film 23 side in a state in which the laminate film 23 is made to contact the wall surface 22a of the outer side region 22A at the secondary seal 22 that structures the injection port frame. As illustrated in FIG. 4 for example, the heat pressing is carried out by heating a hot plate member 30 while causing the hot plate member 30 to contact the laminate film 23 and applying pressure in the arrow A direction. Due to the laminate film 23 being welded to the wall surface 22a of the secondary seal 22 that structures the injection port frame, the spaces 28 within the secondary seal 22 that communicate with the injection ports 25, 26 are sealed by the laminate film 23.

Operation and effects of the power storage device manufacturing method relating to the embodiment of the present disclosure are described here.

In accordance with the power storage device manufacturing method relating to the embodiment of the present disclosure, good sealability of the spaces within the injection port frame that communicate with the injection ports can be obtained.

First, description will be given of the case of a conventional power storage device, and specifically, a case in which the entire injection port frame is structured by one type of resin, i.e., a case in which the outer side region (i.e., the region including the surface contacting the laminate film) and the inner side region (i.e., the region that contacts the outer side region and is disposed further toward the injection ports side than the outer side region that includes the surface contacting the laminate film) are structured by the same resin. When welding of the laminate film and the injection port frame is carried out by heat pressing, welding is carried out at a temperature that is greater than or equal to the melting points Tm or the glass transition temperatures Tg of the resin that structures the injection port frame and the resin that structures the surface of the laminate film that contacts the injection port frame. At this time, the resin of the injection port frame, which resin is in a vicinity of the surface that contacts the laminate film, melts and the fluidity thereof increases, and the injection port frame is pushed-in in the direction in which pressure is applied by the heat pressing. Therefore, the volume of the spaces within the injection port frame that are sealed by the laminate film decreases, and the internal pressure of these spaces rises. If the internal pressure becomes too high, there are cases in which the air contained in the spaces within the injection port frame breaks-through and bulges-out the melted portions of the resin that structures the injection port frame. Due thereto, there are cases in which voids form in the injection port frame at the places that have been broken-through by the air within the spaces, and the spaces within the injection port frame cannot be sealed.

In contrast, in the power storage device relating to the embodiment of the present disclosure, at the injection port frame, the outer side region that includes the surface contacting the laminate film, and the inner side region that contacts the outer side region and is disposed further toward the injection ports side than the outer side region that includes the surface contacting the laminate film, are structured by different resins. Namely, the outer side region is structured by resin L, and the inner side region is structured by resin H. Further, at the laminate film, the region that includes the surface that contacts the injection port frame is structured by resin lam. The melting points Tm or the glass transition temperatures Tg of the resin L that structures the outer side region and the resin lam that structures the surface of the laminate film that contacts the injection port frame are lower than that of the resin H that structures the inner side region.

Namely, the region of the injection port frame that is welded to the laminate film (i.e., the outer side region) is structured by a resin whose melting point Tm or glass transition temperature Tg is low, and the region of the injection port frame that is further toward the battery side than the outer side region (i.e., the inner side region) is structured by a resin whose melting point Tm or glass transition temperature Tg is high. Further, the region of the laminate film that is welded to the injection port frame also is structured by a resin whose melting point Tm or glass transition temperature Tg is low.

Further, at the time of welding the injection port frame and the laminate film by heat pressing, the temperature of the heat pressing is made to be greater than or equal to the melting points Tm or the glass transition temperatures Tg of the resin L and the resin lam, and is made to be less than the melting point Tm or the glass transition temperature Tg of the resin H.

Namely, the heat pressing is carried out at a temperature at which the outer side region at the injection port frame, and the region of the laminate film that is welded to the injection port frame, melt, and at which the inner side region of the injection port frame does not melt. Therefore, at the time of welding the injection port frame and the laminate film, at the injection port frame, only the portion that is the resin whose the melting point Tm or glass transition temperature Tg is low (i.e., the outer side region) becomes a fluid state, and the portion that is the resin whose melting point Tm or glass transition temperature is high (i.e., the inner side region) does not enter into a fluid state. Due thereto, at the time when the injection port frame is pushed-in in the direction in which pressure is applied by the heat pressing, the injection port frame being pushed-in excessively is suppressed. As a result, a rise in the internal pressures of the spaces within the injection port frame is suppressed, and the formation of voids in the injection port frame also is suppressed.

Due thereto, in accordance with the power storage device manufacturing method relating to the embodiment of the present disclosure, good sealability of the spaces within the injection port frame that communicate with the injection ports can be obtained.

### Power Storage Device

Operation and effects of the power storage device relating to the embodiment of the present disclosure are described.

In accordance with the power storage device relating to the embodiment of the present disclosure, good sealability of the spaces within the injection port frame that communicate with the injection ports can be obtained.

In the power storage device relating to the embodiment of the present disclosure, at the injection port frame, the outer side region that includes the surface contacting the laminate film, and the inner side region that contacts the outer side region and is disposed further toward the injection ports side than the outer side region that includes the surface contacting the laminate film, are structured by different resins. Namely, the outer side region is structured by resin L, and the inner side region is structured by resin H. Further, at the laminate film, the region that includes the surface that contacts the injection port frame is structured by resin lam. The melting points Tm or the glass transition temperatures Tg of the resin L that structures the outer side region, and the resin lam that structures the surface of the laminate film that contacts the injection port frame, are lower than the melting point Tm or the glass transition temperature Tg of the resin H that structures the inner side region. Namely, the region of the injection port frame that is welded to the laminate film (i.e., the outer side region) is structured by a resin whose melting point Tm or glass transition temperature Tg is low, and the region at the injection port frame that is further toward the battery side than the outer side region (i.e., the inner side region) is structured by a resin whose melting point Tm or glass transition temperature Tg is high. Further, the region of the laminate film that is welded to the injection port frame also is structured by a resin whose melting point Tm or glass transition temperature Tg is low.

Therefore, at the time of welding the injection port frame and the laminate film by carrying out welding at a temperature that is greater than or equal to the melting points Tm or the glass transition temperatures Tg of the resin L and the resin lam and is less than the melting point Tm or the glass transition temperature Tg of the resin H, there can be obtained the power storage device that has the injection port frame in which the formation of voids is suppressed. Due thereto, in accordance with the power storage device relating to the embodiment of the present disclosure, good sealability of the spaces within the injection port frame that communicate with the injection ports can be obtained.

With regard to the structures of the power storage device relating to the embodiment of the present disclosure and the power storage device manufactured by the power storage device manufacturing method relating to the embodiment of the present disclosure, FIG. 1 through FIG. 4 illustrate a form in which the outer side region 22A at the secondary seal 22 that structures the injection port frame is structured by resin L, and all of the regions other than the outer side region 22A are structured by the resin H. However, the structure of the injection port frame of the power storage device is not limited to this form. For example, the injection port frame may be structured by three or more types of resins. As a specific example, at the injection port frame, there may be a structure in which the outer side region including the surface contacting the laminate film is structured by resin L, and the inner side region that contacts the outer side region and is disposed further toward the injection ports side than the outer side region including the surface contacting the laminate film is structured by resin H, and the region that is even further toward the battery side than the inner side region at the injection port frame (i.e., the region that is disposed further toward the injection ports side than the inner side region and contacts the inner side region but does not contact the outer side region) is structured by a resin other than resin L and resin H.

However, it is preferable that the power storage device be a form in which the outer side region 22A at the injection port frame is structured by the resin L, and all regions other than the outer side region 22A are structured by the resin H.

### Resin H, Resin L and Resin Lam

Examples of the resins that are used for the resin H that structures the outer side region of the injection port frame, the resin L that structures the inner side region of the injection port frame, and the resin lam that structures the surface of the laminate film that contacts the injection port frame, are described.

The combination of, for example, resin H: polypropylene (PP, Tm=160° C.), resin L: polyethylene (PE, Tm=130°° C.), and resin lam: PE (Tm=130° C.) is preferable as the combination of resin H, resin L and resin lam. In this case, in the power storage device manufacturing method relating to the embodiment of the present disclosure, the heat pressing is carried out at a temperature of greater than or equal to 130° C. and less than or equal to 160° C.

Further, the following combinations also are preferable as resin H, resin L and resin lam.
Resin H: modified polyphenylene ether resin (modified PPE resin, Tg=210° C.), resin L: PE (Tm=130° C.), resin lam: PE (Tm=130° C.)
Resin H: modified PPE resin (Tg=210° C.), resin L: PP (Tm=160° C.), resin lam: PP (Tm=160° C.)
Resin H: PP (Tm=160° C.), resin L: polystyrene (PS, Tm=110° C.), resin lam: PS (Tm=110° C.)
Resin H: PP (Tm=160° C.), resin L: acrylonitrile-butadiene-styrene copolymer resin (ABS resin, Tm=100° C.), resin lam: ABS resin (Tm=100° C.)
Resin H: modified PPE resin (Tg=210° C.), resin L: PS (Tm=110° C.), resin lam: PS (Tm=110° C.)
Resin H: modified PPE resin (Tg=210° C.), resin L: ABS resin (Tm=100° C.), resin lam: ABS resin (Tm=100° C.)

Note that it is preferable to use, as the resin L and the resin lam, resins whose melting points Tm or glass transition temperatures Tg are the same, and to use, as the resin H, a resin whose melting point Tm or glass transition temperature Tg is higher than that of the resin L and the resin lam.

### Shapes 1 of Outer Side Region and Inner Side Region of Injection Port Frame

With regard to the structures of the power storage device relating to the embodiment of the present disclosure and the power storage device manufactured by the power storage device manufacturing method relating to the embodiment of the present disclosure, FIG. 1 through FIG. 4 illustrate a form in which the contacting surfaces of the outer side region 22A and the inner side region 22B at the secondary seal 22 that structures the injection port frame are planar. However, the structure of the injection port frame of the power storage device is not limited to this form.

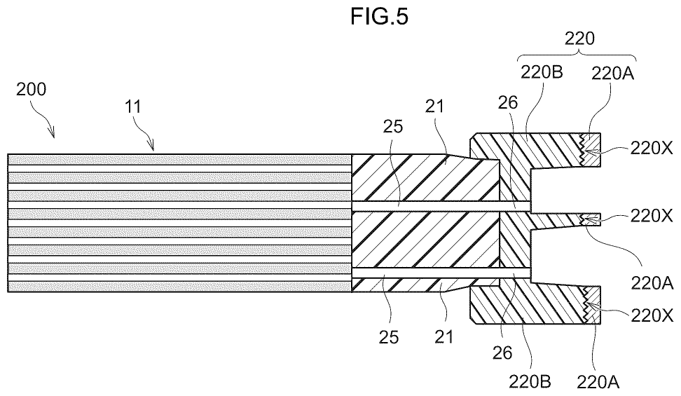

As illustrated in FIG. 5, at a device main body 200 of the power storage device, it is preferable that the contacting surfaces of outer side region 220A and inner side region 220B at a secondary seal 220 that structures the injection port frame are convex/concave shapes that have convex/concave portions 220X. Note that the laminate film is omitted in FIG. 5. By making the contacting surfaces of the outer side region 220A and the inner side region 220B have convex/concave shapes, the surface area of contact between the outer side region 220A and the inner side region 220B can be increased, and the adhesive strength of the outer side region 220A and the inner side region 220B can be increased.

Here, a method of forming the convex/concave shapes at the contacting surfaces of the outer side region 220A and the inner side region 220B is described. First, the inner side region 220B at the secondary seal 220 that structures the injection port frame is molded of resin H (e.g., the inner side region 220B is molded by injection molding). Next, a surface roughening treatment (e.g., a surface roughening treatment by laser illumination) is carried out on the surface of the inner side region 220B which surface is to contact the outer side region 220A, and the convex/concave portions 220X are formed at the contacting surface of the inner side region 220B. Then, the outer side region 220A is molded from resin L (e.g., the outer side region 220A is molded by injection molding) on the contacting surface of the inner side region 220B at which the convex/concave portions 220X have been formed. Due thereto, an injection port frame in which the contacting surfaces of the outer side region 220A and the inner side region 220B are convex/concave shapes is obtained.

### Shapes 2 of Outer Side Region and Inner Side Region of Injection Port Frame

Further, it is preferable to make the shapes of the contacting surfaces of the outer side region and the inner side region of the injection port frame be shapes that latch at the time when the outer side region is tensed in the direction toward the side opposite the injection ports.

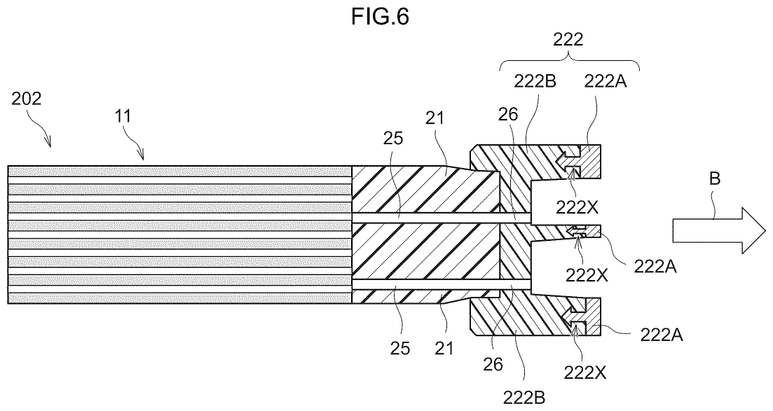

As shown in FIG. 6 for example, a form in which an outer side region 222A enters into an inner side region 222B, and the shapes of entry places 222X are arrow-shaped as seen from the side surface of the electrode stack 11, is an example of shapes that latch.

At a device main body 202 of the power storage device illustrated in FIG. 6, portions of the resin L of the outer side region 222A at a secondary seal 222 that structures the injection port frame enter into the resin H of the inner side region 222B. The shapes of the places 222X where the outer side region 222A enters into the inner side region 222B are arrow-shaped as seen from the side surface of the electrode stack 11. Therefore, at the outer side region 222A, at the time when the outer side region 222A is tensed in the direction (i.e., the arrow B direction) toward the side opposite the injection ports 26, the places 222X latch onto the inner side region 222B. Note that the laminate film is not illustrated in FIG. 6.

By making the shape of the outer side region 222A be a shape that latches onto the inner side region 222B at the time when the outer side region 222A is tensed in the direction toward the side opposite the injection ports 26, the adhesive strength of the outer side region 222A and the inner side region 222B can be increased.

Other forms can be exemplified as examples in which the contacting surfaces of the outer side region and the inner side region at the injection port frame are shapes that latch at the time when the outer side region is tensed in the direction toward the side opposite the injection ports.

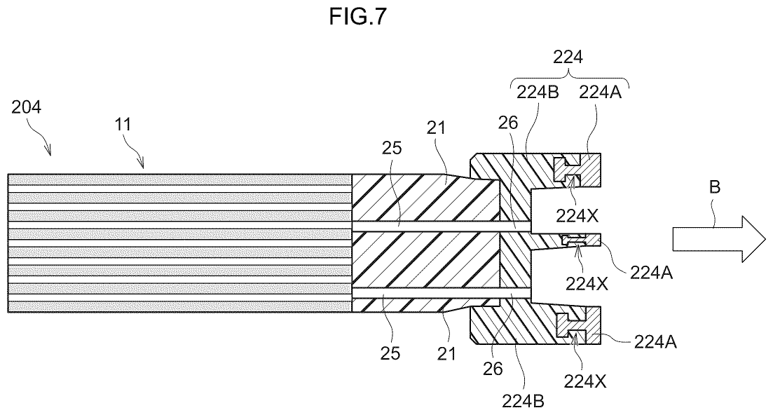

For example, as illustrated in FIG. 7, a form in which an outer side region 224A enters into an inner side region 224B, and the shapes of entry places 224X are shaped as the letter T as seen from the side surface of the electrode stack 11, is an example of the above-described shapes that latch.

At a device main body 204 of the power storage device illustrated in FIG. 7, portions of the resin L of the outer side region 224A at a secondary seal 224 that structures the injection port frame enter into the resin H of the inner side region 224B. The shapes of the places 224X where the outer side region 224A enters into the inner side region 224B are T-shaped as seen from the side surface of the electrode stack 11. Therefore, at the outer side region 224A, at the time when the outer side region 224A is tensed in the direction (i.e., the arrow B direction) toward the side opposite the injection ports 26, the places 224X latch onto the inner side region 224B. Note that the laminate film is not illustrated in FIG. 7.

By making the shape of the outer side region 224A be a shape that latches onto the inner side region 224B at the time when the outer side region 224A is tensed in the direction toward the side opposite the injection ports 26, the adhesive strength of the outer side region 224A and the inner side region 224B can be increased.

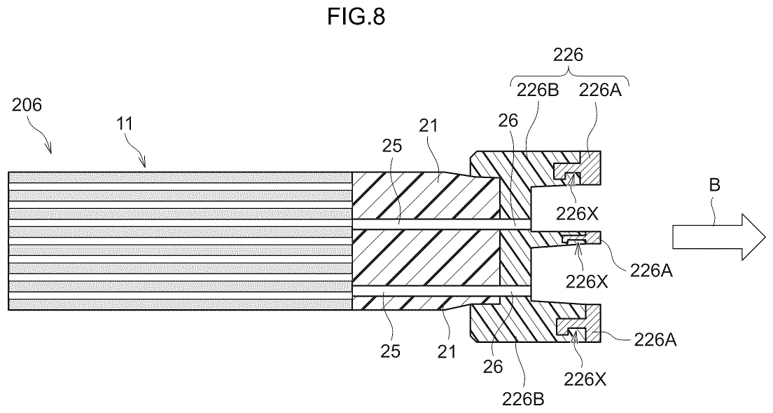

Moreover, as illustrated in FIG. 8, a form in which an outer side region 226A enters into an inner side region 226B, and the shapes of entry places 226X are shaped as the letter L as seen from the side surface of the electrode stack 11, is another example of the above-described shapes that latch.

At a device main body 206 of the power storage device illustrated in FIG. 8, portions of the resin L of the outer side region 226A at a secondary seal 226 that structures the injection port frame enter into the resin H of the inner side region 226B. The shapes of the places 226X where the outer side region 226A enters into the inner side region 226B are L-shaped as seen from the side surface of the electrode stack 11. Therefore, at the time when the outer side region 226A is tensed in the direction (i.e., the arrow B direction) toward the side opposite the injection ports 26, the places 226X latch onto the inner side region 226B. Note that the laminate film is not illustrated in FIG. 8.

By making the shape of the outer side region 226A be a shape that latches onto the inner side region 226B at the time when the outer side region 226A is tensed in the direction toward the side opposite the injection ports 26, the adhesive strength of the outer side region 226A and the inner side region 226B can be increased.

Here, a method of forming the injection port frame that has an above-described latching shape is described by using the form of FIG. 6 as an example. First, at the time of molding, from the resin H, the inner side region 222B at the secondary seal 222 that structures the injection port frame, the inner side region 222B, which is a shape such that the portions corresponding to the places 222X are cavities, is molded by using a molding method such as injection molding. Next, the outer side region 222A is molded from the resin L (e.g., the outer side region 222A is molded by injection molding) so as to fill-in the portions that are the cavities at the inner side region 222B (i.e., the portions corresponding to the places 222X). The injection port frame that has the above-described latching shape is thereby obtained. Note that injection port frames having forms illustrated in FIG. 7 and FIG. 8 can be molded similarly.

### Shapes 3 of Outer Side Region and Inner Side Region of Injection Port Frame

It is preferable that the shapes of the contacting surfaces of the outer side region and the inner side region at the injection port frame are shapes such that the surface areas of contact of the both are large.

For example, as illustrated in above-described FIG. 5, a shape that is such that the contacting surfaces of the outer side region and the inner side region that structure the injection port frame are convex/concave is an example of a shape in which the surface areas of contact of the both are large.

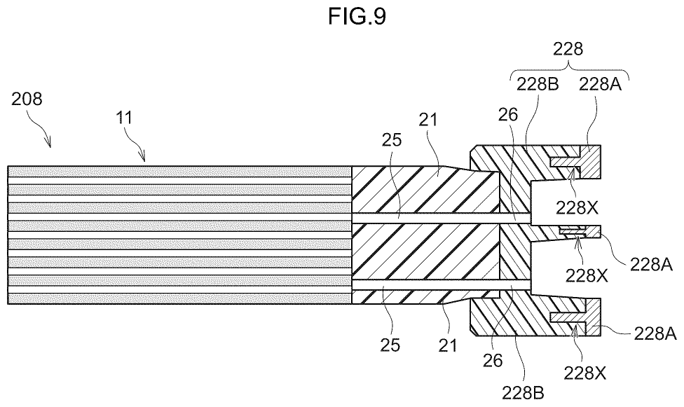

Further, as illustrated in FIG. 9, a form in which an outer side region 228A enters into an inner side region 228B is another example of a shape that is such that the surface areas of contact of the both are large.

At a device main body 208 of the power storage device illustrated in FIG. 9, portions of the resin L of the outer side region 228A at a secondary seal 228 that structures the injection port frame enter into the resin H of the inner side region 228B. The shapes of places 228X where the outer side region 228A enters into the inner side region 228B are flat-plate-shaped as seen from the side surface of the electrode stack 11. Namely, the outer side region 228A and the inner side region 228B contact one another in forms like nails piercing in. Note that the laminate film is omitted in FIG. 9.

By making the shapes of the contacting surfaces of the outer side region 228A and the inner side region 228B in the injection port frame be shapes that are such that the contacting surface areas of the both are large, the adhesive strength of the outer side region 228A and the inner side region 228B can be increased.

Note that the injection port frame of the form illustrated in FIG. 9 can be molded by a similar method as that of the injection port frame illustrated in FIG. 6.

A battery, which structures the power storage device relating to the embodiment of the present disclosure and the power storage device manufactured by the power storage device manufacturing method relating to the embodiment of the present disclosure, is described next.

An electrode stack (the electrode stack 11 in FIG. 1 through FIG. 6) is an example of the battery. The electrode stack is structured by plural electrodes that are layered via separators. The electrodes have, for example, stacks of plural bipolar electrodes.

### Positive Electrode Composite Material Layer

The positive electrode has a positive electrode composite material layer.

The positive electrode composite material layer contains a positive electrode active material, and may further contain a binder for example.

Examples of the positive electrode active material are lithium-nickel-cobalt-manganese complex oxides (hereinafter simply called “LNCM” upon occasion). The simplest LNCM is expressed by the general formula LiNiₓCo_{y}Mn_{z}O₂ (where x, y, z in the formula are 0<x<1, 0<y<1, 0<z<1, and x+y+z=1). In addition to Li, Ni, Co and Mn, LNCM may contain other added elements such as transition metal elements other than Ni, Co, Mn, and main group metal elements other than Li. LNCM has a layered crystal structure. LNCM exceeds 50 mass % of the entire positive electrode active material, and it is good for LNCM to be contained in an amount of 80-100 mass % for example. The positive electrode active material may be structured by LNCM alone. Further, lithium iron phosphate (LiFePO₄, LFP), lithium manganese iron phosphate (LMFP), or the like may be used in the positive electrode active material layer.

Examples of other positive electrode active materials are lithium-nickel complex oxides, lithium-cobalt complex oxides, and lithium-nickel-manganese complex oxides.

Examples of the binder contained in the positive electrode composite material layer are vinyl halide resins such as polyvinylidene fluoride (PVdF).

The positive electrode composite material layer may contain other components such as a conductive material for example. Examples of conductive materials are carbon that is hard to graphitize, carbon that is easy to graphitize such as carbon black, and graphite.

### Negative Electrode Composite Material Layer

The electrode has a negative electrode composite material layer.

The negative electrode composite material layer contains a negative electrode active material, and may further contain a binder for example.

Examples of the negative electrode active material are graphite-based carbons such as natural graphite, artificial graphite and amorphous coated graphite, metal compounds, elements that can be alloyed with lithium or compounds thereof, and boron-added carbons. Silicon and tin are examples of elements that can be alloyed with lithium. The proportion of graphite contained in the graphite-based carbon is greater than or equal to approximately 50 mass %, and is preferably greater than or equal to 80 mass %.

Examples of the binder contained in the negative electrode active material are rubbers such as styrene-butadiene copolymer (SBR), and vinyl halide resins such as polyvinylidene fluoride (PVdF).

The negative electrode composite material layer may further contain other components such as a thickener for example. Examples of the thickener are celluloses such as carboxymethylcellulose (CMC).

### Collectors: Positive Electrode Collector and Negative Electrode Collector

At the power storage device relating to the embodiment of the present disclosure, plural bipolar electrodes, which have a negative electrode composite material layer on one surface of the collector and a positive electrode composite material layer on the other surface of the collector for example, are layered via separators. Conductive members formed from metals that have good conductivity (e.g., aluminum, stainless steel (SUS), Ni, Cr, Au, Pt, Fe, Ti and Zn) are suitable as the collector.

### Separator

The separator is an electrically insulating, porous film. The separator electrically isolates the positive electrode and the negative electrode. The separator may have a thickness of 5-30 um for example. The separator can be structured by, for example, a porous polyethylene (PE) film or a porous polypropylene (PP) film. The separator may be a multilayer structure. For example, the separator may be structured by a porous PP film, a porous PE film, and a porous PP film being layered in that order. The separator may have a heat-resistant layer on the surface thereof. The heat-resistant layer contains a heat-resisting material. Examples of the heat-resisting material are metal oxide particles such as alumina, and high melting point resins such as polyimide.

### Electrolyte

The power storage device relating to the embodiment of the present disclosure further has an electrolyte. Electrolyte liquids are examples of the electrolyte, and non-aqueous electrolyte liquids are particularly preferable. Description of non-aqueous electrolyte liquids is given hereinafter.

### Solvent

The non-aqueous electrolyte liquid contains a solvent (a non-aqueous solvent) and an electrolyte.

Examples of the solvent (the non-aqueous solvent) are N,N-diethyl-N-methyl-N-(2-methoxyethyl)ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).

### Electrolyte

Lithium salts are examples of the electrolyte in the electrolyte liquid. Examples of lithium salts are lithium bis(fluorosulfonyl)imide (LiFSI), LiPF₆ (lithium hexafluorophosphate), lithium tetrafluoroborate (LiBF₄), and Li[N(CF₃SO₂)₂].

The amount of the electrolyte may be, for example, 1.0-2.0 mol/L, and is preferably 1.0-1.5 mol/L.

In addition to the solvent and the electrolyte, the electrolyte liquid may contain various additives such as thickeners, film-forming agents, and gas generating agents. The electrolyte is typically a non-aqueous electrolyte liquid that is in a liquid state at ordinary temperatures (e.g., 25+10° C.). The electrolyte liquid typically assumes a liquid state in usage environments of batteries (e.g., environments of temperatures of −20-+60° C.).

### Applications

Examples of the application of the power storage device relating to the embodiment of the present disclosure are the power source of a hybrid vehicle (HEV), a plug-in hybrid vehicle (PHEV), or an electric vehicle (BEV).

### EXPLANATION OF REFERENCE NUMERALS

4 power storage device, 11 electrode stack, 12 sealing member, 20, 200, 202 device main body, 21 primary seal, 22, 220, 222, 224, 226, 228 secondary seal, 22A, 220A, 222A, 224A, 226A, 228A outer side region, 22B, 220B, 222B, 224B, 226B, 228B inner side region, 22a wall surface, 23 laminate film, 25, 26 injection port, 28 space, 30 hot plate member, 220X convex/concave portion, 222X, 224X, 226X, 228X place

1. A method of manufacturing a power storage device having a battery, injection ports for injecting an electrolyte liquid into the battery, a tubular member surrounding the injection ports, and a laminate film welded to the tubular member and sealing spaces within the tubular member that communicate with the injection ports, the method comprising:
a welding the tubular member and the laminate film by causing the laminate film to contact the tubular member and carrying out heat pressing from the laminate film side,
wherein
at the tubular member, a first region including a surface that contacts the laminate film is structured by resin L, and a second region that is disposed further toward the injection ports side than the first region and that contacts the first region is structured by resin H, and, at the laminate film, a third region including a surface that contacts the tubular member is structured by resin lam, and
melting points Tm or glass transition temperatures Tg of the resin L, the resin H and the resin lam satisfy following conditions a, b and c.
a: Melting point Tm or glass transition temperature Tg of the resin L is less than melting point Tm or glass transition temperature Tg of the resin H.
b: Melting point Tm or glass transition temperature Tg of the resin lam is less than the melting point Tm or the glass transition temperature Tg of the resin H.
c: A temperature of the heat pressing is greater than or equal to the melting point Tm or the glass transition temperature Tg of the resin L, is greater than or equal to the melting point Tm or the glass transition temperature Tg of the resin lam, and is less than the melting point Tm or the glass transition temperature Tg of the resin H.

2. The method of manufacturing a power storage device of claim 1, wherein the resin His polypropylene, and the resin L and the resin lam are polyethylene.

3. The method of manufacturing a power storage device of claim 1, wherein a shape of the battery as seen in a thickness direction of the battery is rectangular, and lengths of sides of the rectangle are a height of greater than or equal to 1000 mm and a width of greater than or equal to 10,000 mm.

4. The method of manufacturing a power storage device of claim 1, wherein the tubular member has convex/concave shapes at surfaces where the second region and the first region contact one another.

5. The method of manufacturing a power storage device of claim 1, wherein, at the tubular member, surfaces where the second region and the first region contact one another are shapes that latch at a time when the first region is tensed in a direction toward a side opposite the injection ports.

6. A power storage device comprising:
a battery;
holes communicating with an interior of the battery;
a tubular member surrounding the holes; and
a laminate film welded to the tubular member and sealing spaces within the tubular member that communicate with the holes,
wherein
at the tubular member, a first region including a surface that contacts the laminate film is structured by resin L, and a second region that is disposed further toward the holes side than the first region and that contacts the first region is structured by resin H, and, at the laminate film, a third region including a surface that contacts the tubular member is structured by resin lam, and
melting points Tm or glass transition temperatures Tg of the resin L, the resin H and the resin lam satisfy following conditions a and b.
a: Melting point Tm or glass transition temperature Tg of the resin L is less than melting point Tm or glass transition temperature Tg of the resin H.
b: Melting point Tm or glass transition temperature Tg of the resin lam is less than the melting point Tm or the glass transition temperature Tg of the resin H.

7. The power storage device of claim 6, wherein the resin H is polypropylene, and the resin L and the resin lam are polyethylene.

8. The power storage device of claim 6, wherein a shape of the power storage device as seen in a thickness direction of the power storage device is rectangular, and lengths of sides of the rectangle are a height of greater than or equal to 1000 mm and a width of greater than or equal to 10,000 mm.

9. The power storage device of claim 6, wherein the tubular member has convex/concave shapes at surfaces where the second region and the first region contact one another.

10. The power storage device of claim 6, wherein, at the tubular member, surfaces where the second region and the first region contact one another are shapes that latch at a time when the first region is tensed in a direction toward a side opposite the holes.
